(19) United States
(12) Patent Application Publication
(10) Pub. No.: US 2024/0272896 A1
(43) Pub. Date: Aug. 15, 2024

(54) CENTER DEVICE

(71) Applicant: DENSO CORPORATION, Kariya-City (JP)

(72) Inventors: Hideo YOSHIMI, Kariya-City (JP); Yuzo HARATA, Kariya-City (JP); Nao KOJIMA, Kariya-City (JP); Masaaki ABE, Kariya-City (JP); Koto TOMATSU, Kariya-City (JP); Kazuhiro UEHARA, Kariya-City (JP)

(21) Appl. No.: 18/645,001

(22) Filed: Apr. 24, 2024

Related U.S. Application Data
(63) Continuation-in-part of application No. PCT/JP2022/031103, filed on Aug. 17, 2022.

(30) Foreign Application Priority Data
Oct. 28, 2021 (JP) 2021-176558

(51) Int. Cl. G06F 8/65; G06F 3/06; G07C 5/08; H04W 4/40

(52) U.S. Cl. CPC G06F 8/65; G06F 3/0604; G07C 5/085; H04W 4/40

(57) ABSTRACT

A center device manages data to be written in an electronic control device mounted on a vehicle and performs, by an application program, a plurality of functions to transmit update data to the vehicle by wireless communication. An application program implementing at least one of the functions adopts a serverless architecture. The application program is activated upon occurrence of an event and is dynamically allocated with a resource in an on-demand manner for execution of a code of the application program. The resource allocated to the application program is released when the execution of the code is terminated.

### CROSS REFERENCE TO RELATED APPLICATIONS

The present application is a continuation-in-part application of International Patent Application No. PCT/JP2022/031103 filed on Aug. 17, 2022 which designated the U.S. and claims the benefit of priority from Japanese Patent Application No. 2021-176558 filed on Oct. 28, 2021. The entire disclosures of all of the above applications are incorporated herein by reference.

### TECHNICAL FIELD

The present disclosure relates to a center device that manages data to be written into an electronic control device mounted on a vehicle.

### BACKGROUND

For example, a related art discloses a technique in which an update program for an ECU is distributed from a server to an in-vehicle device over the air (OTA) and in which the update program is rewritten on the vehicle side.

### SUMMARY

A center device manages data to be written in an electronic control device mounted on a vehicle and performs, by an application program, a plurality of functions to transmit update data to the vehicle by wireless communication. An application program implementing at least one of the functions adopts a serverless architecture. The application program is activated upon occurrence of an event and is dynamically allocated with a resource in an on-demand manner for execution of a code of the application program. The resource allocated to the application program is released when the execution of the code is terminated.

### BRIEF DESCRIPTION OF DRAWINGS

The foregoing and other objects, features, and advantages of the present disclosure will become more apparent from the following detailed description with reference to the accompanying drawings. The drawings are as follows:

FIG. 1 is a functional block diagram illustrating a configuration of an OTA center in a first embodiment;

FIG. 2 is a diagram illustrating an example in which a function of the OTA center is implemented by applying Amazon Web Service (AWS);

FIG. 3 is a flowchart schematically illustrating processing performed between a vehicle-side system and the OTA center;

FIG. 4A is a flowchart (part 1) illustrating a process from reception of vehicle configuration information to transmission of campaign information;

FIG. 4B is a flowchart (part 2) illustrating the process from the reception of the vehicle configuration information to the transmission of the campaign information;

FIG. 5A is a flowchart (part 1) illustrating a process from registration of the campaign information to registration of a delivery package to a contents delivery network (CDN) distribution section;

FIG. 5B is a flowchart (part 2) illustrating the process from the registration of the campaign information to the registration of the delivery package to the CDN distribution section;

FIG. 6 is a flowchart illustrating a process from data access by an automobile to delivery of the package by the CDN distribution section;

FIG. 7 is a flowchart illustrating a registration process of software update data;

FIG. 8A is a flowchart (part 1) illustrating a process from registration of case information to generation of a package;

FIG. 8B is a flowchart (part 2) illustrating the process from the registration of the case information to the generation of the package;

FIG. 9 is a flowchart (part 3) illustrating the process from the registration of the case information to the generation of the package;

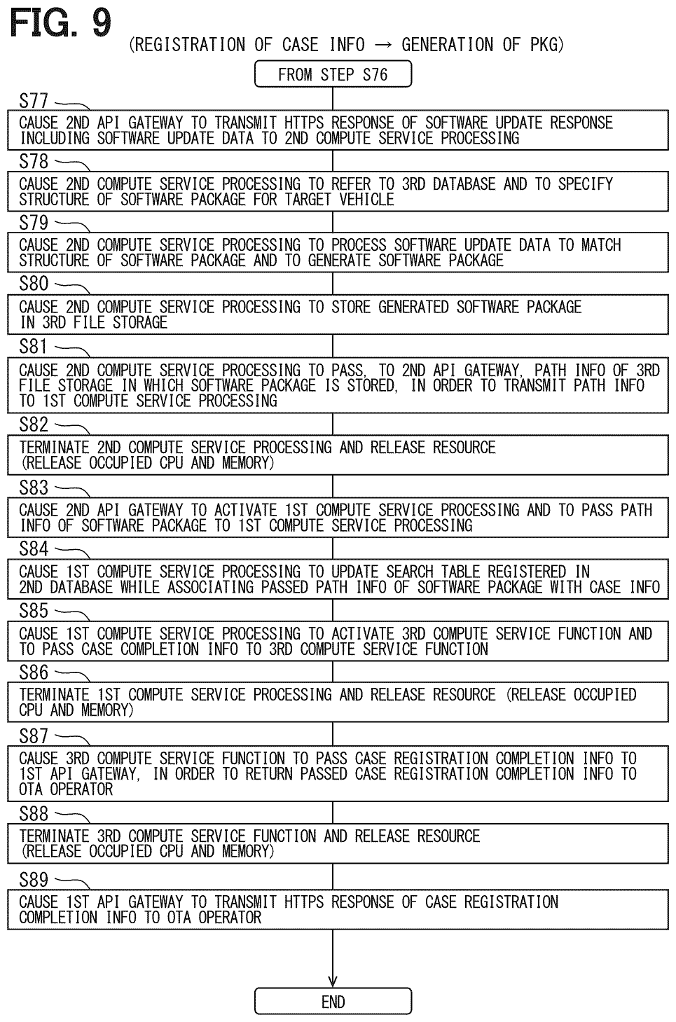

FIG. 10 is a diagram for describing an effect obtained by accumulating data in a queuing buffer section for a certain period of time and then passing the data to a compute service function section on the next stage;

FIG. 11 is a diagram illustrating a processing form of each of a server model and a serverless model;

FIG. 12 is a diagram illustrating a running cost of each of the server model and the serverless model;

FIG. 13 is a diagram illustrating how data is sorted into each queue in a queuing buffer section in a second embodiment;

FIG. 14 is a flowchart showing part of a process from reception of vehicle configuration information to transmission of campaign information;

FIG. 15 is a flowchart showing part of a process, in a third embodiment, from reception of vehicle configuration information to transmission of campaign information;

FIG. 16 is a flowchart showing part of a process, in a fourth embodiment, from reception of vehicle configuration information to transmission of campaign information;

FIG. 17 is a diagram illustrating how data is sorted into each queue in a queuing buffer section in a fifth embodiment;

FIG. 18 is a flowchart showing part of a process from reception of vehicle configuration information to transmission of campaign information;

FIG. 19 shows a sixth embodiment and is a functional block diagram illustrating a configuration of an OTA center;

FIG. 20 is a flowchart showing part of a process from reception of vehicle configuration information to transmission of campaign information;

FIG. 21 is a functional block diagram illustrating a configuration of an OTA center in a seventh embodiment;

FIG. 22 is a flowchart showing part of a process from reception of vehicle configuration information to transmission of campaign information;

FIG. 23 is a diagram illustrating an example in which a function of an OTA center is implemented by applying AWS in an eighth embodiment;

FIG. 24 is a functional block diagram 24 assuming a case where the function of an OTA center is configured by mainly applying the server architecture;

FIG. 25 is a diagram 25 illustrating a tendency of server access by time of day in a connected car service; and

FIG. 26 is a diagram illustrating differences in the number of automobile sales between regions.

### DETAILED DESCRIPTION

In recent years, with diversification of vehicle control such as a drive assist function and an automated driving function, a scale of application programs for vehicle control, diagnosis, and the like mounted on an electronic control device (hereinafter, referred to as ECU (electronic control unit)) of a vehicle is increasing. In addition, along with version upgrade for improving functions and the like, there is an increasing opportunity to rewrite an application program in an ECU, that is, opportunity to perform so-called re-programming. On the other hand, along with the development of communication networks and the like, the connected car technology has also become widespread.

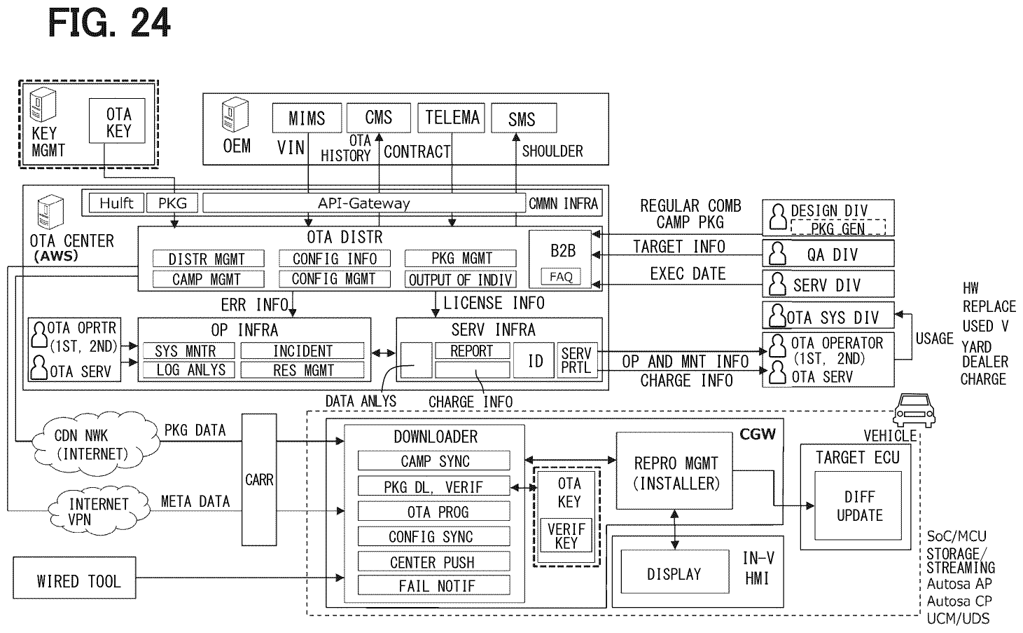

In a case where the center device disclosed in a related art is actually configured, for example, the center device is configured as illustrated in FIG. 24, and it is assumed that each of the management blocks and the like constituting the center device is generally realized by an architecture based on use of a server. Note that, in the present application, an environment or configuration in which an application program is executed on the assumption that a server is used is referred to as “server architecture”. In other words, in the server architecture, resources are always allocated to the application program, and the program is executed as a resident-type process.

In FIG. 24, “KEY MGMT” corresponds to a key management center. “OTA KEY” corresponds to an OTA key issuing and managing. “OEM” corresponds to an OEM back office. “MIMS” corresponds to a manufacturing information-related management system. “CMS” corresponds to a customer management-related system. “OTA HISTORY” corresponds to OTA result and implementation history. “TELEMA” corresponds to a telematics contract system. “CONTRACT” corresponds to a telematics contract conclusion and cancellation. “SMS” corresponds to an SMS distribution center. “SHOULDER” corresponds to a shoulder tap. “OTA CENTER” corresponds to an OTA center (AWS). “CMMN INFRA corresponds to a common infrastructure. “OTA DISTR” corresponds to an OTA distribution system. “DISTR MGMT” corresponds to a distribution management. “CONFIG INFO” corresponds to a vehicle configuration information management. “PKG MGMT” corresponds to a package management. “CAMP MGMT” corresponds to a campaign management. “CONFIG MGMT” corresponds to a configuration information management. “OUTPUT OF INDIV” corresponds to a management and output of states of individual vehicles. “B2B” corresponds to a B2B portal. “OTA OPRTR (1ST, 2ND)” corresponds to an OTA operator (1st, 2nd). “OTA SERV” corresponds to an OTA service provider. “ERR INFO” corresponds to a system log, log for analysis, error information. “OP INFRA” corresponds to an operational infrastructure. “SYS MNTR” corresponds to a system monitoring. “INCIDENT” corresponds to an incident and problem management. “LOG ANLYS” corresponds to a log analysis. “RES MGMT” corresponds to an asset management and resource management. “LICENSE INFO” corresponds to a license information, charge source data, OTA record, id information. “SERV INFRA” corresponds to a service infrastructure. “DATA ANLYS” corresponds to a data analysis. “REPORT” corresponds to a report output. “CHARGE INFO” corresponds to a charging information output. “ID” corresponds to a ID unified management. “SERV PRTL” corresponds to a service portal. “REGULAR COMB” corresponds to a regular combination. “CAMP PKG” corresponds to a campaign information package file. “TARGET INFO” corresponds to a target vehicle information. “EXEC DATE” corresponds to a campaign target vehicle execution date. “OP AND MNT INFO” corresponds to an operation and maintenance information. “CHARGE INFO” corresponds to charging and billing information. “DESIGN DIV” corresponds to vehicle design division. “PKG GEN” corresponds to package generation. “QA DIV” corresponds to a quality assurance division. “SERV DIV” corresponds to a service division. “OTA SYS DIV” corresponds to an OTA system management division. “OTA OPERATOR (1ST, 2ND)” corresponds to an OTA operator (1st, 2nd). “OTA SERV corresponds to an OTA service provider. “USAGE” corresponds to usage situation and charging information. “HW REPLACE” corresponds to a HW replacement. “USED V” corresponds to used vehicle sales. “YARD” corresponds to a yard. “DEALER” corresponds to a dealer. “CHARGE” corresponds to a charging. “CDN NWK (INTERNET)” corresponds to a CDN network (internet network). “INTERNET VPN” corresponds to an internet VPN. “WIRED TOOL” corresponds to a wired reprogramming tool. “PKG DATA” corresponds to a package data. “META DATA” corresponds to a metadata. “CARR” corresponds to a carrier center. “DOWNLOADER” corresponds to an utility/downloader. “CAMP SYNC” corresponds to a campaign information synchronization. “PKG DL, VERIF” corresponds to a package download and verification. “OTA PROG” corresponds to an OTA state progress notification. “CONFIG SYNC” corresponds to a vehicle configuration information synchronization. “CENTER PUSH” corresponds to a center Push. “FAIL NOTIF” corresponds to a failure log information notification. “OTA KEY” corresponds to an OTA key. “VERIF KEY” corresponds to a verification key replacement. “REPRO MGMT” corresponds to a re-programming management (Installer). “DISPLAY” corresponds to a screen display. “IN-V HMI” corresponds to an in-vehicle HMI. “TARGET ECU” corresponds to a target ECU. “DIFF UPDATE” corresponds to a difference update. “STORAGE/STREAMING” corresponds to a storage/streaming.

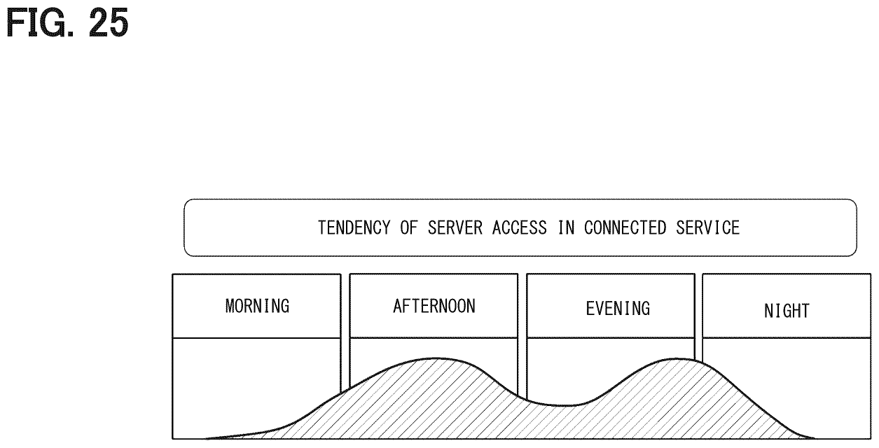

As illustrated in FIG. 25, it is assumed that access from vehicles to the server included in the center device is frequent in the day time and is less frequent during the night. Therefore, if the server is operated during the night, the cost for the operation is wasteful.

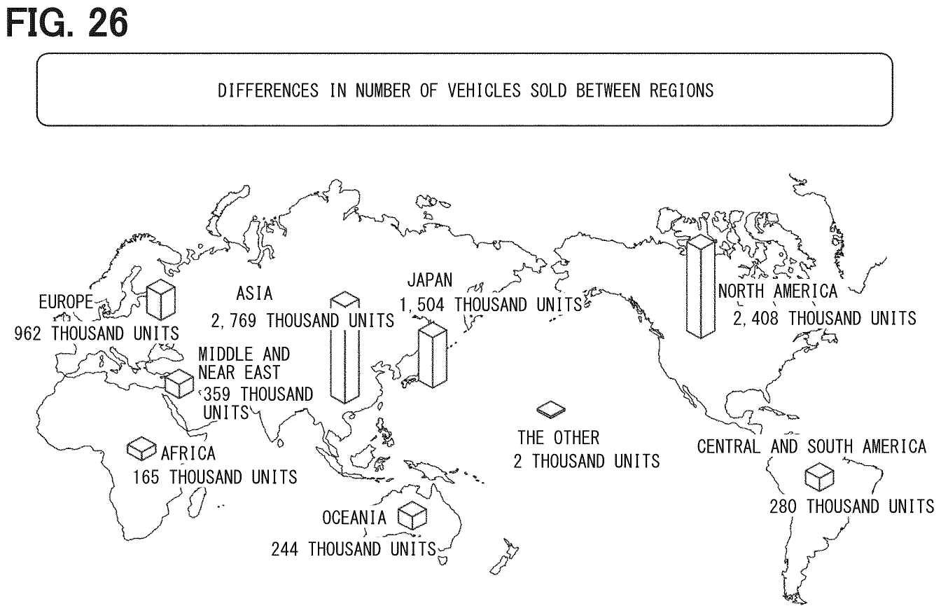

In addition, it is legally required to install a center device compatible with the connected car in each country. Therefore, if a system of the same scale is constructed for each country, the cost of operating the server is also wasteful in an area where there are not many vehicles (see FIG. 26).

The present disclosure provides a center device that performs wireless communication with a plurality of vehicles at a lower cost.

According to a center device described in claim 1 or claim 2, the center device manages data to be written in an electronic control device mounted on a vehicle and performs, by an application program, a plurality of functions to transmit update data to the vehicle by wireless communication. An application program implementing at least one of the functions adopts a serverless architecture in which the application program is activated upon occurrence of an event and is dynamically allocated with a resource in an on-demand manner for execution of a code of the application program and in which the resource allocated to the application program is released when the execution of the code is terminated.

As described above, the frequency of access from vehicles to the center device varies depending on time of day, and the number of vehicles itself varies depending on regions. If the serverless architecture is adopted for an application program that implements at least some functions, resources are dynamically allocated and the program is activated every time access from a vehicle occurs, and the resources are released when the execution of the code is completed. Therefore, as compared with the case of adopting the server architecture executed as a resident-type process, consumption of computing resources can be saved, and as a result, a running cost required for the infrastructure can be reduced.

### First Embodiment

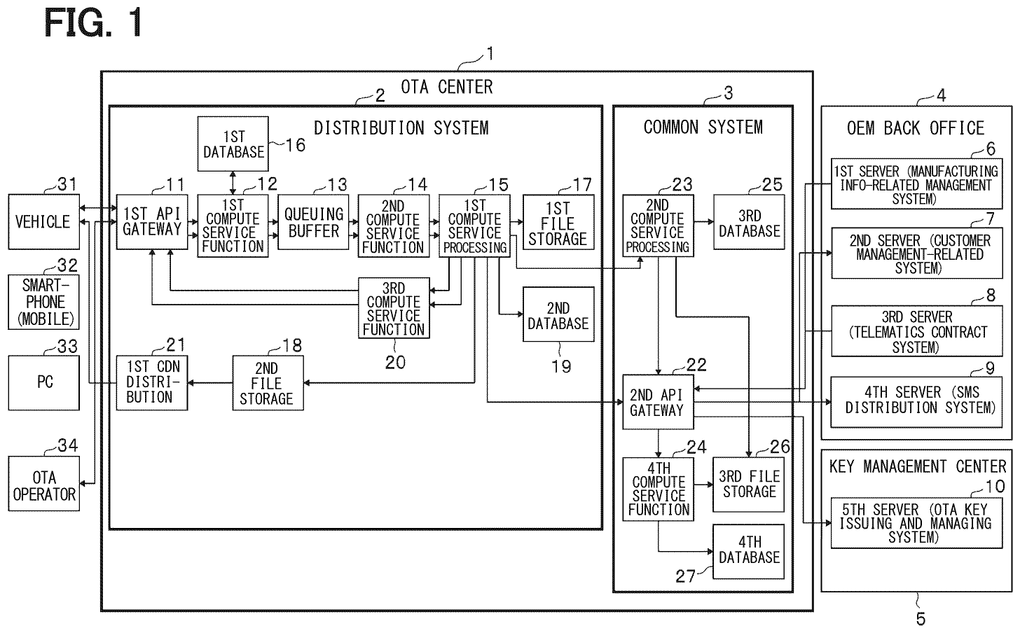

Hereinafter, a first embodiment will be described. As illustrated in FIG. 1, an OTA center 1 that is a center device of the present embodiment includes a distribution system 2 and a common system 3. In the common system 3, a delivery package including an update program and data for the ECU to be delivered to an automobile 31, which is a vehicle, is generated and managed, and the generated delivery package is delivered to the automobile 31 via the distribution system 2 by wireless communication, that is, via an OTA.

When the common system 3 generates a package, necessary data is transmitted and received to and from an original equipment manufacturer (OEM) back office 4 and a key management center 5 that are external server systems. The OEM back office 4 includes a first server 6 to a fourth server 9, and the like. These servers 6 to 9 are similar to those illustrated in FIG. 24, and are respectively systems for manufacturing information management, customer management, telematics contract, and short message service (SMS) delivery. The key management center 5 includes a fifth server 10 that is a system to issue and manage a key used in the OTA.

The first server 6 to the fifth server 10 adopt the above-described server architecture, resources are always allocated to application programs, and the application programs are executed as resident-type processes.

An application programming interface (API) gateway section (1) 11 of the distribution system 2 performs wireless communication with the automobile 31 and an OTA operator 34. Data received by the API gateway section 11 is sequentially transferred to a compute service function section (1) 12, a queuing buffer section 13, a compute service function section (2) 14, and the compute service processing section (1) 15. The compute service function section 12 accesses a database section (1) 16. The compute service processing section 15 accesses a file storage section (1) 17, a file storage section (2) 18, and a database section (2) 19. The database section 19 stores campaign information that is update information of software that corresponds to the automobile 31 whose program needs to be updated.

Data that is output from the compute service processing section 15 is output to the API gateway section 11 via a compute service function section (3) 20. A contents delivery network (CDN) distribution section 21 accesses the file storage section 18 and delivers data buffered in the file storage section 18 to the automobile 31 via the OTA. The CDN distribution section 21 is an example of a network distribution section.

The API gateway section (2) 22 of the common system 3 inputs and outputs data to and from: the compute service processing section 15 of the distribution system 2; and a compute service processing section (2) 23 and a compute service function section (4) 24 included in the common system 3. The compute service processing section 23 accesses a database section (3) 25 and a file storage section (3) 26. The compute service function section 24 accesses the file storage section 26 and a database section (4) 27. The API gateway section 22 also accesses respective ones of the servers 6 to 10 included in the OEM back office 4 and the key management center 5.

In the illustrated configuration, transmission and reception of commands and data are indicated by lines for convenience of description. However, even when lines are not drawn, it is possible to call the processing sections, the function sections, and the management sections and to access the database sections and the storage sections.

In the above configuration, the compute service function sections 12, 14, 20, and 24 and the compute service processing sections 15 and 23 adopt a serverless architecture. The “serverless architecture” is activated upon occurrence of an event, and resources are automatically allocated for execution of the code of an application program in an on-demand manner. Then, when the execution of the code is completed, the allocated resources are automatically released, and the serverless architecture is based on the design concept opposed to the above-described “server architecture”.

The “serverless architecture” is activated upon occurrence of an event, resources are dynamically allocated for execution of the code of an application program, and when the execution of the code is completed, the allocated resources are released. When the execution of the code is completed, the resources are dynamically released. The resource may be released immediately after completion of the execution of the code, or may be released after waiting for a predetermined time, for example, 10 seconds, after completion of the execution.

Here, four principles to configure a serverless architecture includes:
Instead of a server, a computing service is used to execute a program code in an on-demand manner;
A function is straight and has only a single purpose;
A push-based event-driven pipeline is configured; and
A thicker and stronger front end is configured.

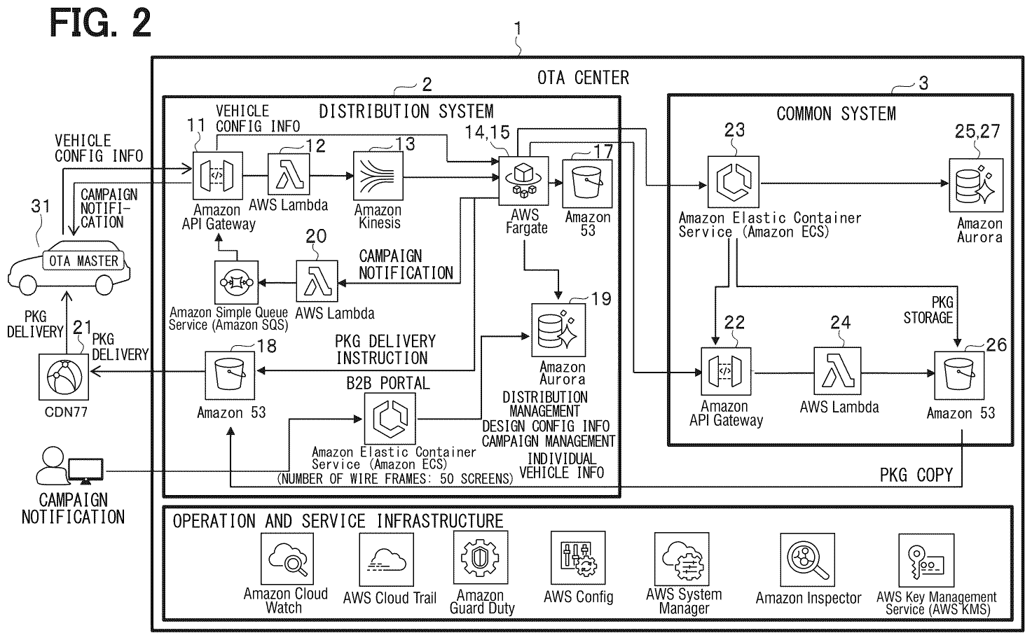

FIG. 2 is an example of a case where a center device 1 illustrated in FIG. 1 is configured using the Amazon Web Service (AWS) cloud.
Amazon API Gateway: corresponds to the API gateway sections 11 and 22.
AWS Lambda: corresponds to the compute service function sections 12, 20, and 24.
Amazon Kinesis: corresponds to the queuing buffer section 13.
AWS Fargate: corresponds to the compute service function section 14 and the compute service processing section 15.
Amazon S3: corresponds to the file storage sections 17, 18, and 26.
Amazon Aurora: corresponds to the database sections 19, 25, and 27.

Note that the CDN77 corresponds to the CDN distribution section 21 and is a service provided by CDN77 co., ltd. The CDN77 may be replaced with the Amazon CloudFront service provided by AWS.

Furthermore, the CDN distribution section 21 is not limited to CDN77 provided by CDN77 co., ltd. or the Amazon CloudFront service provided by AWS and corresponds to any service or server that implements a contents delivery network. The Amazon Web Service (AWS) cloud is an example of a cloud service that provides a serverless architecture. In the embodiment, the configuration described or illustrated in the drawings is appropriately changed by a function provided by a cloud service.

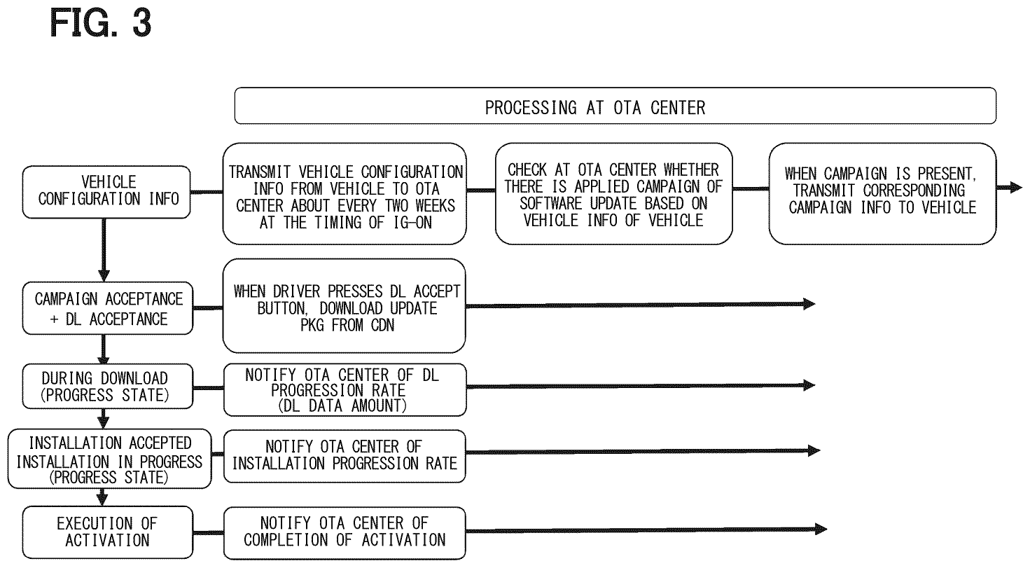

Next, the operation of the present embodiment will be described. As illustrated in FIG. 3, in a phase of “vehicle configuration information synchronization”, vehicle configuration information is transmitted to the OTA center 1 at the timing of an ignition switch being turned ON, in the automobile 31, every two weeks, for example. When a campaign occurs, a short message may be transmitted from the fourth server 9 to a campaign target vehicle, and the short message may trigger the transmission of the vehicle configuration information to the OTA center 1. The vehicle configuration information is information related to hardware and software of an ECU mounted on the vehicle. Based on the transmitted vehicle configuration information, the OTA center 1 checks whether there is campaign information to be applied to software update. Then, if there is corresponding campaign information, the campaign information is transmitted to the automobile 31. Furthermore, the following process is referred to as synchronization process of vehicle configuration information: when the vehicle configuration information is transmitted by the automobile 31, the transmitted information is updated to newer information compared with the vehicle configuration information of the automobile 31 held on the OTA center 1 side.

In a phase of “campaign acceptance+DL acceptance”, when the driver of the automobile 31 receiving the campaign information presses a button, displayed on a screen of an in-vehicle device, for accepting download, data package for updating a program is downloaded from the CDN distribution section 21. During the download, the automobile 31 notifies the OTA center 1 of the progression rate of the download process.

When completion of the download leads to “installation accepted” and installation is performed, a progression rate of the installation process is notified of from the automobile 31 to the OTA center 1. When completion of the installation process leads to “execution of activation” in the automobile 31 and activation is then completed, the OTA center 1 is notified of the completion of the activation.

Hereinafter, details of each process described above will be described.

### <Reception of Vehicle Configuration Information→Transmission of Campaign Information>

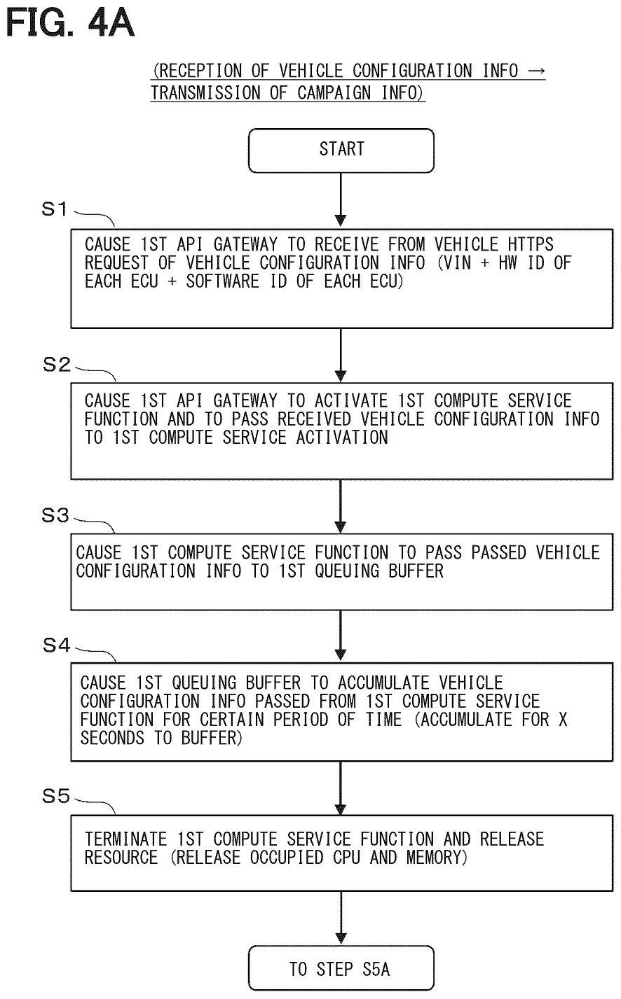

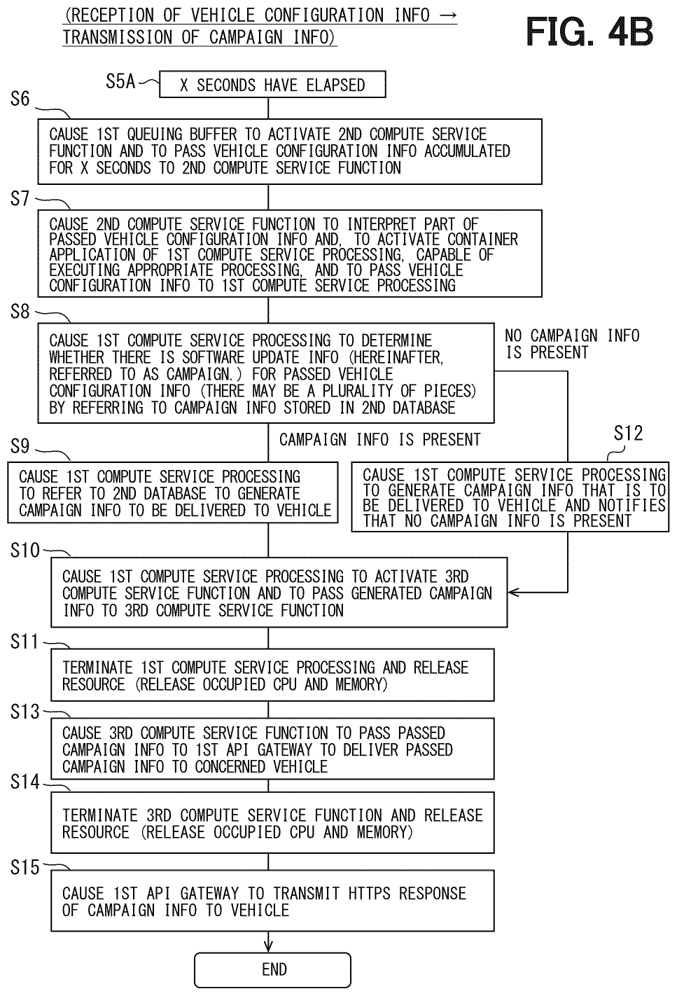

As illustrated in FIGS. 4A and 4B, the API gateway section 11 receives a hypertext transfer protocol secure (HTTPS) request of the vehicle configuration information from the automobile 31 (step S1). The request contents are, for example, a vehicle identification number (VIN), a hardware ID of each ECU, a software ID of each ECU, and the like. Next, the API gateway section 11 activates the compute service function section 12 and then passes the received vehicle configuration information to the function section 12 (step S2).

The compute service function section 12 passes the vehicle configuration information to the queuing buffer section 13 (step S3). The queuing buffer section 13 accumulates and buffers the passed vehicle configuration information for a certain period of time, for example, 1 second or several seconds (step S4). Then, the compute service function section 12 terminates processing and releases the resources such as the CPU and the memory occupied to perform the process (step S5). Note that the compute service function section 12 may receive a TCP port number from the API gateway section 11 as necessary and may store the TCP port number in a shared memory.

When a certain period of time has elapsed (step S5A), the queuing buffer section 13 activates the compute service function section 14 and passes the vehicle configuration information accumulated within the certain period of time to the compute service function section 14 (step S6). The queuing buffer section 13 is an example of an access buffer control section. The compute service function section 14 interprets a part of the content of the passed vehicle configuration information and activates a container application, of the compute service processing section 15, capable of executing appropriate processing, and then passes the vehicle configuration information to the compute service processing section 15 (step S7).

The container application in the compute service processing section 15 includes: a container application related to generation of campaign information; a container application related to registration of a delivery package; and a container application related to generation of a package. The compute service function section 14 interprets the passed information and starts a corresponding container application.

Here, the container is a container formed on a host OS as a logical section, in which libraries, programs, and the like necessary to cause an application to operate are put together in one form. Resources of the OS are logically separated and shared and used by a plurality of containers. An application executed in the container is referred to as a container application.

The compute service processing section 15 accesses the database section 19 and determines whether there is campaign information that is software update information corresponding to the passed vehicle configuration information (step S8). When campaign information is present but the campaign information is in an incomplete form, the compute service processing section 15 refers to the database section 19 to generate campaign information to be delivered to the automobile 31 (step S9). The incomplete form is, for example, a state where information necessary for delivery to the automobile 31 is missing. Here, the compute service processing section 15 is an example of a campaign determination section and a campaign generation section. Furthermore, the compute service function section 14 corresponds to a first compute service section, and the compute service processing section 15 corresponds to a second compute service section.

Note that, in step S9, when campaign information is present and all the information to be delivered to the automobile 31 is prepared, the process proceeds to step S10.

The compute service processing section 15 activates the compute service function section 20 and passes the generated campaign information to the compute service function section 20 (step S10). Then, the compute service processing section 15 terminates the process and releases the resources such as the CPU and the memory occupied to perform the process (step S11). When campaign is not present in step S8, campaign information to be delivered to the automobile 31 to notify that “there is no campaign” is generated (step S12), and then the process proceeds to step S10. In step S10, the compute service processing section 15 passes, to the compute service function section 20, the campaign information to notifying that “there is a campaign” or the campaign information to notify that “there is no campaign”.

The compute service function section 20 passes the passed campaign information to the API gateway section 11 to deliver the passed campaign information to the corresponding automobile 31. Then, the compute service function section 20 terminates the process and releases the resources such as the CPU and the memory occupied to perform the process (step S14). The API gateway section 11 transmits an HTTPS response including the campaign information to the automobile 31 (step S15). The automobile 31 receives the HTTPS response including the campaign information. The API gateway section 11 is an example of a campaign transmission section.

In the above process, the compute service function section 20 may acquire as necessary a TCP port number stored by the compute service function section 12 from the shared memory, and may request the API gateway section 11 to deliver the HTTPS response corresponding to the TCP port number.

### <Registration of Campaign Information→Registration of Delivery Package for CDN Distribution Section 21>

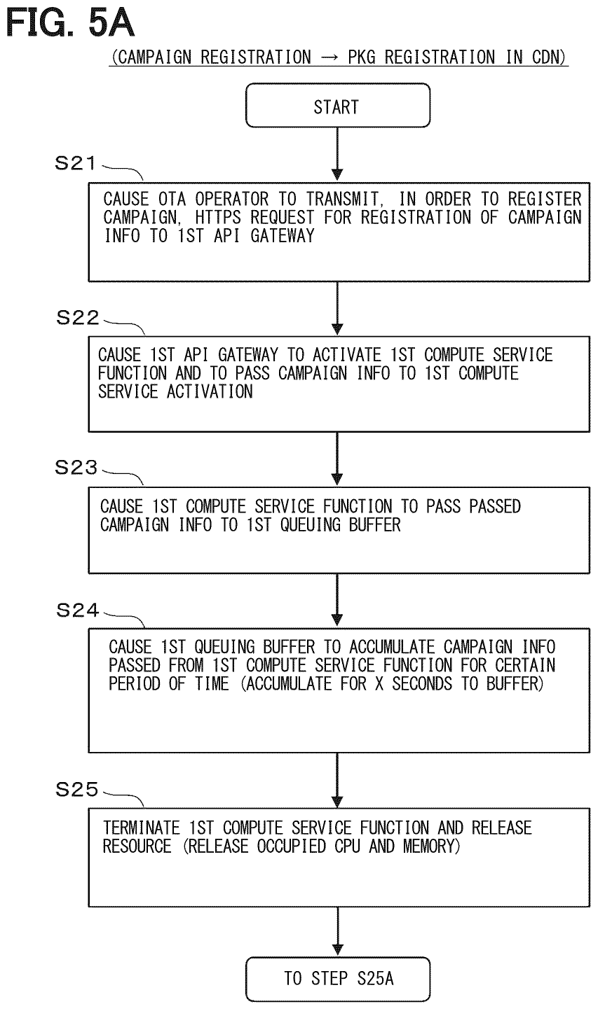

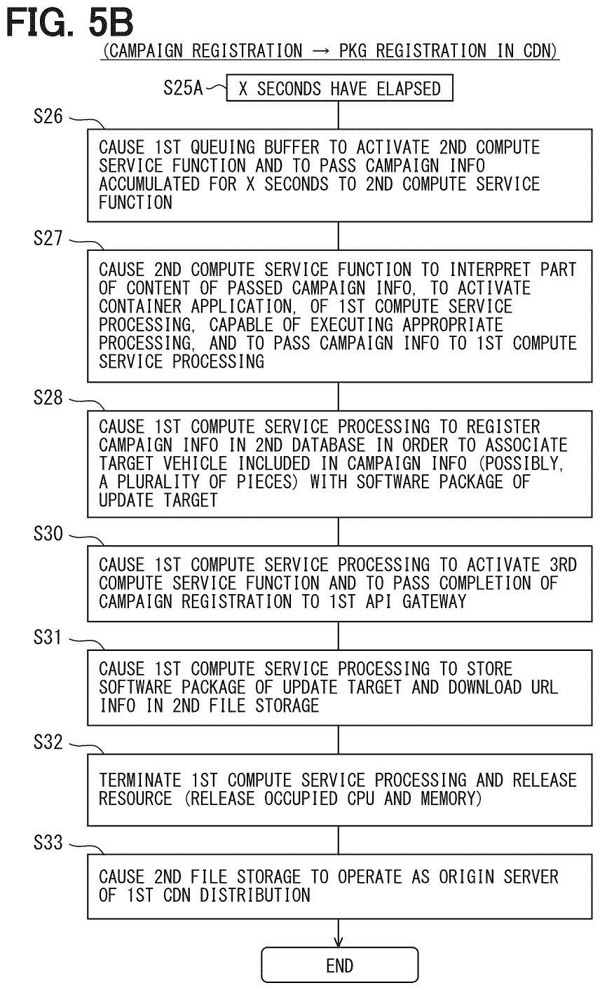

As illustrated in FIGS. 5A and 5B, the OTA operator 34 transmits an HTTPS request for registration of the campaign information (step S21). The API gateway section 11 activates the compute service function section 12 and then passes the received campaign information to the compute service function section 12 (step S22).

The compute service function section 12 passes the campaign information to the queuing buffer section 13 (step S23). The queuing buffer section 13 accumulates and buffers the passed campaign information for a certain period of time (step S24). Then, the compute service function section 12 terminates the process and releases the resources such as the CPU and the memory occupied to perform the process (step S25). The compute service function section 12 is an example of a campaign registration section and corresponds to a fifth compute service section.

When a certain period of time has elapsed (step S25A), the queuing buffer section 13 activates the compute service function section 14 and passes the campaign information accumulated within the certain period of time to the compute service function section 14 (step S26). The compute service function section 14 interprets a part of the content of the passed campaign information and activates a container application, of the compute service processing section 15, capable of executing appropriate processing, and then passes the campaign information to the compute service processing section 15 (step S27). The compute service function section 14 is an example of the campaign registration section and corresponds to a sixth compute service section.

In order to associate the target vehicle included in the passed campaign information with a software package of update target, the compute service processing section 15 registers the campaign information in the database section 19 (step S28). The compute service processing section 15 further activates the compute service function section 20 to pass a notification indicating that the registration of the campaign information is completed, to the API gateway section 11 (step S30). The compute service processing section 15 is an example of the campaign registration section and corresponds to a fourth compute service section.

Next, the compute service processing section 15 stores in the file storage section 18 the software package of update target and URL information for download (step S31). Then, the compute service processing section 15 terminates the process and releases the resources such as the CPU and the memory occupied to perform the process (step S32). Then, the file storage section 18 operates as an origin server of the CDN distribution section 21 (step S33). The compute service processing section 15 is an example of a package distribution section and corresponds to a third compute service section.

The origin server is a server in which original data exists. In the present embodiment, the file storage section 18 stores all of the software packages of update target and the URL information for download.

<Data Access from Automobile→Transmission of Delivery Package from CDN to Automobile>

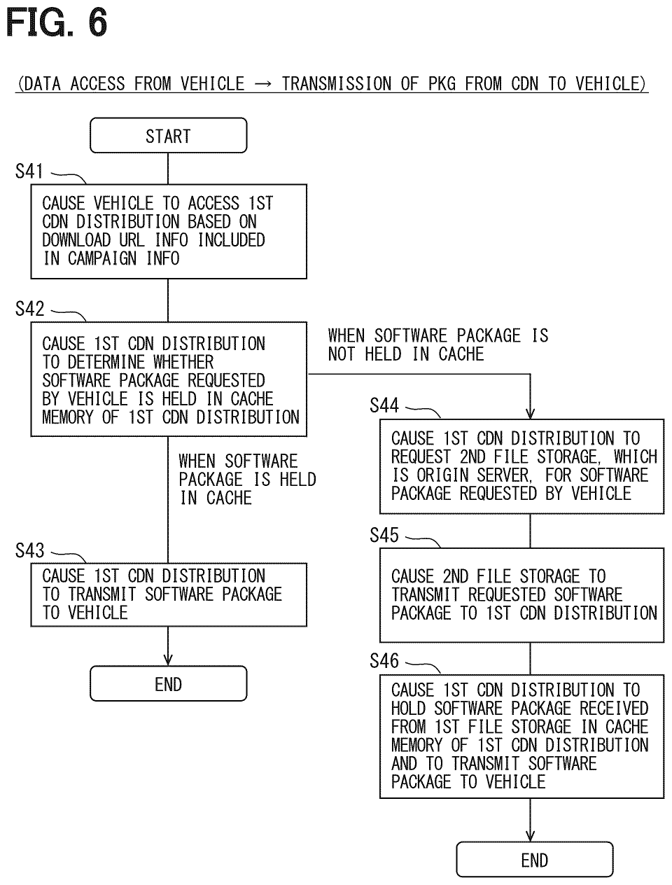

As illustrated in FIG. 6, the automobile 31, more specifically, an OTA master including a data communication module (DCM) and a central ECU that are mounted on the automobile 31 accesses the CDN distribution section 21, based on the download URL information included in the campaign information (step S41). The CDN distribution section 21 determines whether the software package requested from the automobile 31 is held in a cache memory of the CDN distribution section 21 (step S42). When the software package is held in the cache memory, the CDN distribution section 21 transmits the software package to the automobile 31 (step S43).

On the other hand, when the requested software package is not held in the cache memory, the CDN distribution section 21 requests the file storage section 18, which is the origin server, for the software package (step S44). Then, the file storage section 18 transmits the requested software package to the CDN distribution section 21 (step S45). The CDN distribution section 21 holds the software package received from the file storage section 18 in the cache memory of the CDN distribution section 21 and transmits the software package to the automobile 31 (step S46).

### <Registration of Software Update Data>

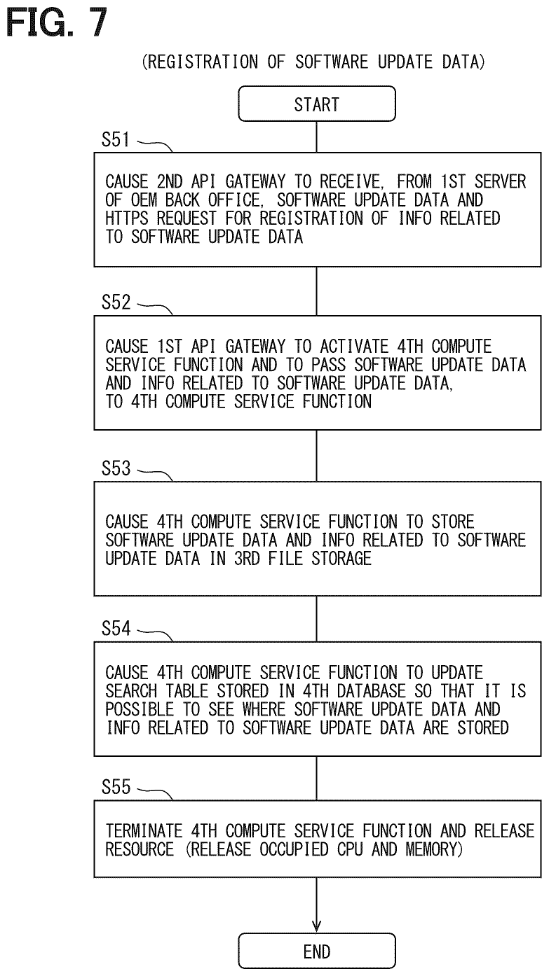

As illustrated in FIG. 7, the API gateway section 22 receives as an HTTPS request a registration request of the software update data and information related to the software update data, from the first server 6 of the OEM back office 4 (step S51). The API gateway section 22 activates the compute service function section 24 and passes the software update data and the relevant information to the compute service function section 24 (step S52). The compute service function section 24 stores the software update data and the relevant information in the file storage section 26 (step S53).

The compute service function section 24 updates a search table stored in the database section 27 so that it is possible to refer to where the software update data and the relevant information are stored (step S54). Then, the compute service function section 24 terminates the process and releases the resources such as the CPU and the memory occupied to perform the process (step S55).

### <Case Information→Generation of Package>

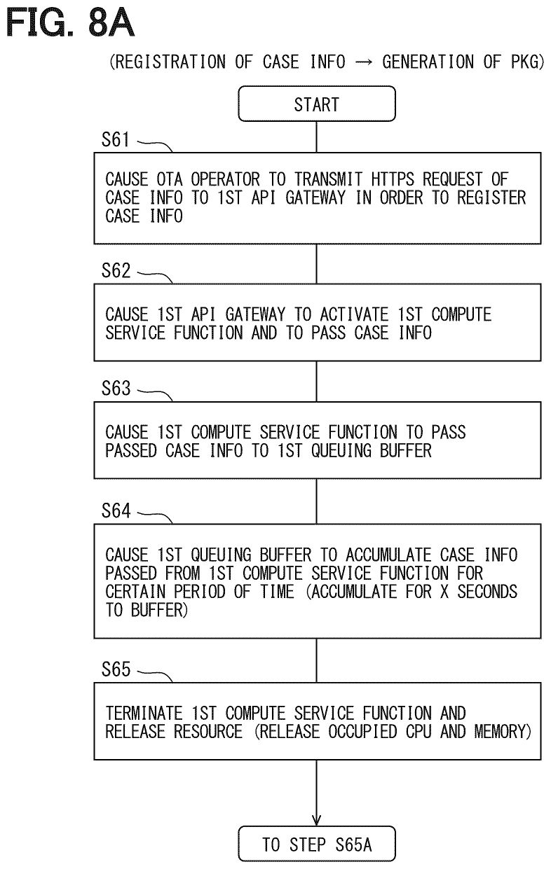

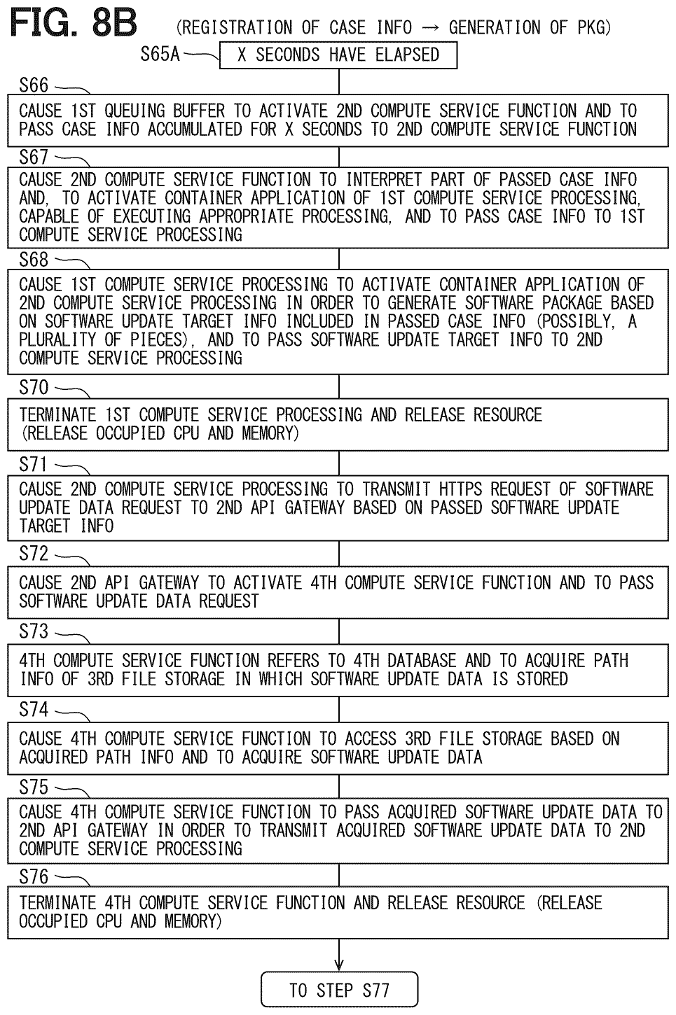

As illustrated in FIGS. 8A and 8B, in order to register the case information, the OTA operator 34 transmits an HTTPS request of case information to the API gateway section 11 (step S61). The case information is information in which hardware information and software information of ECU to which a certain delivery package is applicable. The API gateway section 11 activates the compute service function section 12 and then passes the received case information to the function section 12 (step S62).

The compute service function section 12 passes the case information to the queuing buffer section 13 (step S63). The queuing buffer section 13 accumulates and buffers the passed case information for a certain period of time (step S64). The compute service function section 12 terminates the process and releases the resources such as the CPU and the memory occupied to perform the process (step S65). Note that the compute service function section 12 may receive a TCP port number from the API gateway section 11 as necessary and may store the TCP port number in a shared memory.

When a certain period of time has elapsed, the queuing buffer section 13 activates the compute service function section 14 and passes the case information accumulated within the certain period to the compute service function section 14 (step S66). The compute service function section 14 interprets a part of the content of the passed case information and activates a container application, of the compute service processing section 15, capable of executing appropriate processing, and then passes the case information to the compute service processing section 15 (step S67).

The compute service processing section 15 accesses the database section 19, activates a container application in the compute service processing section 23 in order to generate a software package on the basis of software update target information included in the passed case information, and passes the software update target information to the compute service processing section 23 (step S68). Then, the compute service processing section 15 terminates the process and releases the resources such as the CPU and the memory occupied to perform the process (step S70).

The compute service processing section 23 transmits an HTTPS request of a software update data request to the API gateway section 22 on the basis of the passed software update target information (step S71). The API gateway section 22 activates the compute service function section 24 and passes the software update data request to the compute service function section 24 (step S72). The compute service function section 24 refers to the database section 27 to acquire path information of the file storage section 26 in which the software update data is stored (step S73).

The compute service function section 24 accesses the file storage section 26 on the basis of the acquired path information and acquires the software update data (step S74). Then, in order to transmit the acquired software update data to the compute service processing section 23, the compute service function section 24 passes the software update data to the API gateway section 22 (step S75). The compute service function section 24 terminates the process and releases the resources such as the CPU and the memory occupied to perform the process (step S76). The compute service function section 24 is an example of a data management section.

The API gateway section 22 transmits an HTTPS response of a software update response including the software update data to the compute service processing section 23 (step S77). The compute service processing section 23 refers to the database section 25 and specifies the structure of the software package for the target vehicle (step S78). Then, the compute service processing section 23 processes the software update data to match the structure of the specified software package, thereby generating a software package (step S79). The compute service processing section 23 stores the generated software package in the file storage section 26 (step S80). The compute service processing section 23 is an example of a package generation section.

In order to transmit to the compute service processing section 15 path information of the file storage section 26 in which the software package is stored, the compute service processing section 23 passes the path information to the API gateway section 22 (step S81). The compute service processing section 23 terminates the process and releases the resources such as the CPU and the memory occupied to perform the process (step S82).

The API gateway section 22 activates the compute service processing section 15 and passes the path information of the software package to the compute service processing section 15 (step S83). The compute service processing section 15 associates the passed path information of the software package with the case information to update the search table registered in the database section 19 (step S84). The compute service processing section 15 activates the compute service function section 20 and passes case registration completion information to the compute service function section 20 (step S85). The compute service processing section 15 terminates the process and releases the resources such as the CPU and the memory occupied to perform the process (step S86).

In order to return the passed case registration completion information to the OTA operator 34, the compute service function section 20 passes the case registration completion information to the API gateway section 11 (step S87). The compute service function section 20 terminates the process and releases the resources such as the CPU and the memory occupied to perform the process (step S88). The API gateway section 11 transmits an HTTPS response of the case registration completion information to the OTA operator 34 (step S89).

In the above process, the compute service function section 20 may acquire as necessary a TCP port number stored by the compute service function section 12 from the shared memory, and may request the API gateway section 11 to deliver the HTTPS response corresponding to the TCP port number.

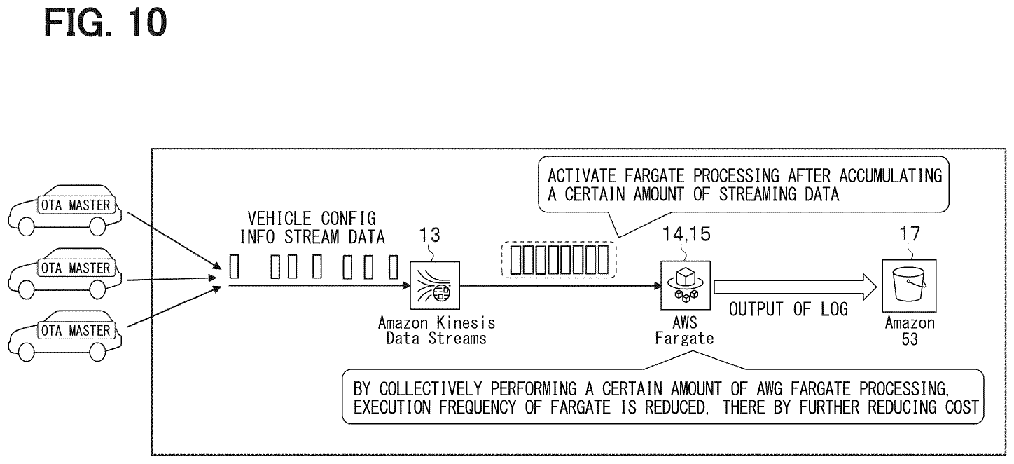

Next, advantageous effects of the present embodiment will be described. As illustrated in FIG. 10, in the queuing buffer section 13, a certain amount of stream data of the vehicle configuration information transmitted from each automobile 31 is accumulated and is then passed to the compute service function section 14 on the next stage and compute service processing section 15. Assuming that the above function is implemented by AWS Fargate, consumption of computing resources can be saved by reducing an execution frequency of processing.

In the queuing buffer section 13, the campaign information and the case information are accumulated for a certain period of time similarly to the vehicle configuration information and are then passed to the compute service function section 14 on the next stage, so that the execution frequency of processing is reduced, thereby suppressing consumption of computing resources.

In addition, the queuing buffer section 13 may store the vehicle configuration information, the campaign information, and the case information in a single queuing buffer, or may store the information in a different queuing buffer section 13 for each type of information.

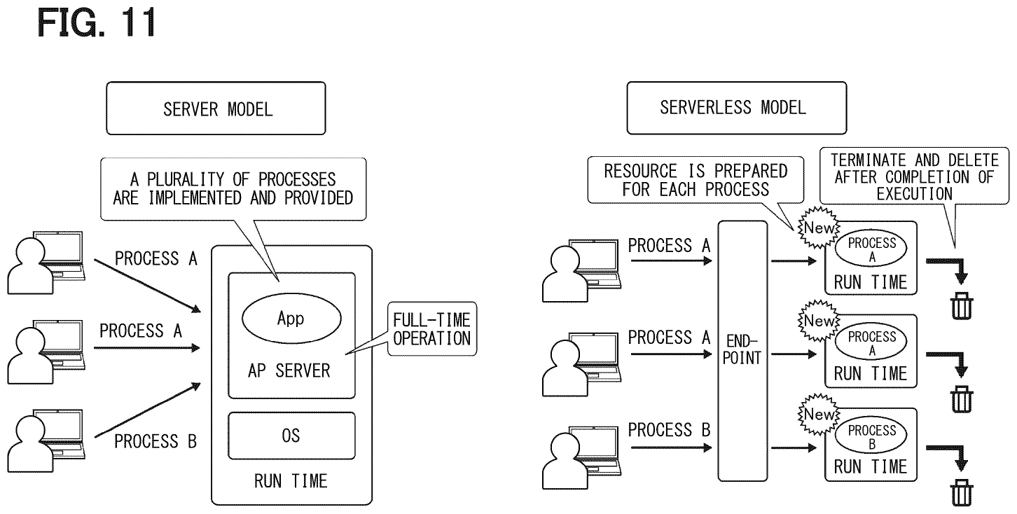

Meanwhile, as illustrated in FIG. 11, in the conventional server model, an application program and a server always operate while occupying resources, and a single server is used to perform a plurality of processes. In contrast, in the model adopting the serverless architecture as in the present embodiment, when each process is requested, the corresponding application program is activated, and when the process is terminated, the execution of the program is terminated, and the program is deleted. Therefore, at this point of time, the resources used for the process are released.

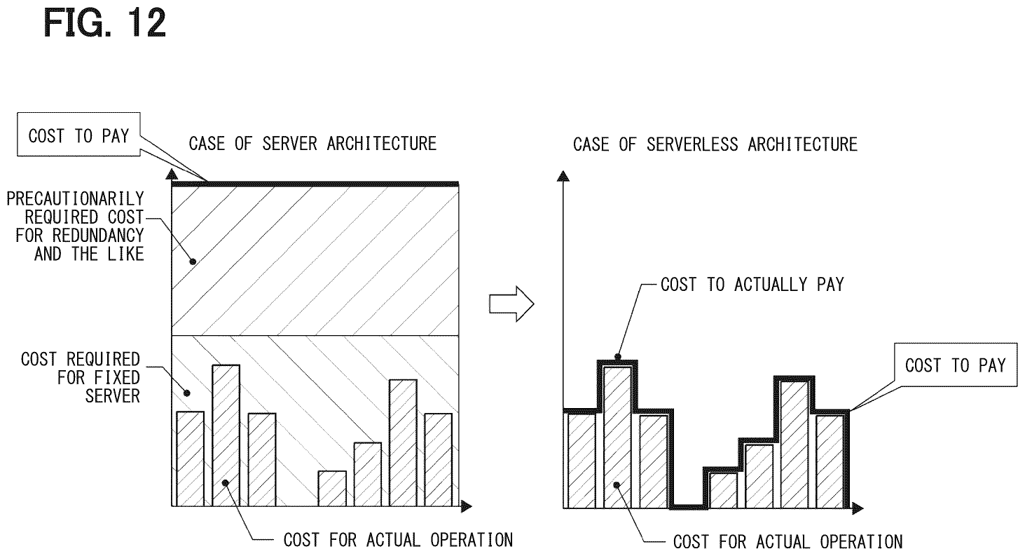

As a result, as illustrated in FIG. 12, in the conventional server model, a fixed cost associated with constant operation of the server at all times is required as compared with the cost for actual operation. In addition, if the server is precautionarily made redundant, the cost is further required. In contrast, when the serverless architecture is adopted as in the present embodiment, only the cost for actual operation substantially needs to be borne, so that the running cost required for the infrastructure can be greatly reduced.

As described above, according to the present embodiment, the OTA center 1 manages data to be written to a plurality of ECUs mounted on the automobile 31, and executes, by an application program, a plurality of functions for transmitting update data to the automobile 31 by wireless communication. At that time, a serverless architecture is adopted in which an application program that implements at least some functions is activated upon occurrence of an event, resources are dynamically allocated for execution of the code of the application program in an on-demand manner, and the resources allocated to the application program are released when the execution of the code is completed.

In the program adopting the serverless architecture, every time access from the automobile 31 is occurred, the program is activated with resources being dynamically allocated, and when the execution of the code is completed, the resources are released. Therefore, as compared with the case of adopting the server architecture executed as a resident-type process, consumption of computing resources of the infrastructure can be saved, and as a result, a running cost required for the infrastructure can be reduced.

### Second Embodiment

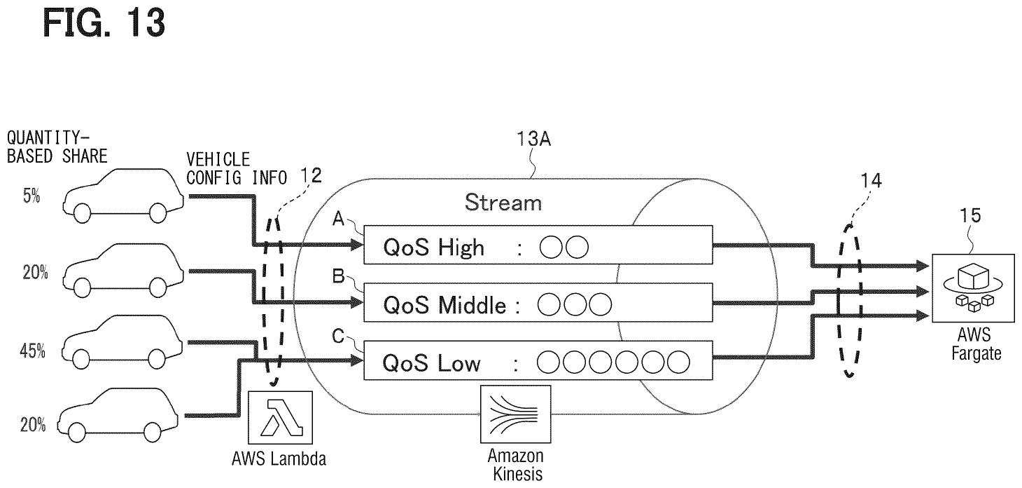

Hereinafter, the same parts as those in the first embodiment will be denoted by the same reference numerals and will not be described, and different parts will be described. As illustrated in FIG. 13, in general, the quantity-based share varies depending on the price range of the automobile 31, the share of the high-end model is low, and the shares of the middle and low-end models are high. Therefore, in a queuing buffer section 13A, the queue is divided depending on price ranges of the automobile 31 so that the OTA process for the high-end model is preferentially performed.

### <Reception of Vehicle Configuration Information→Transmission of Campaign Information>

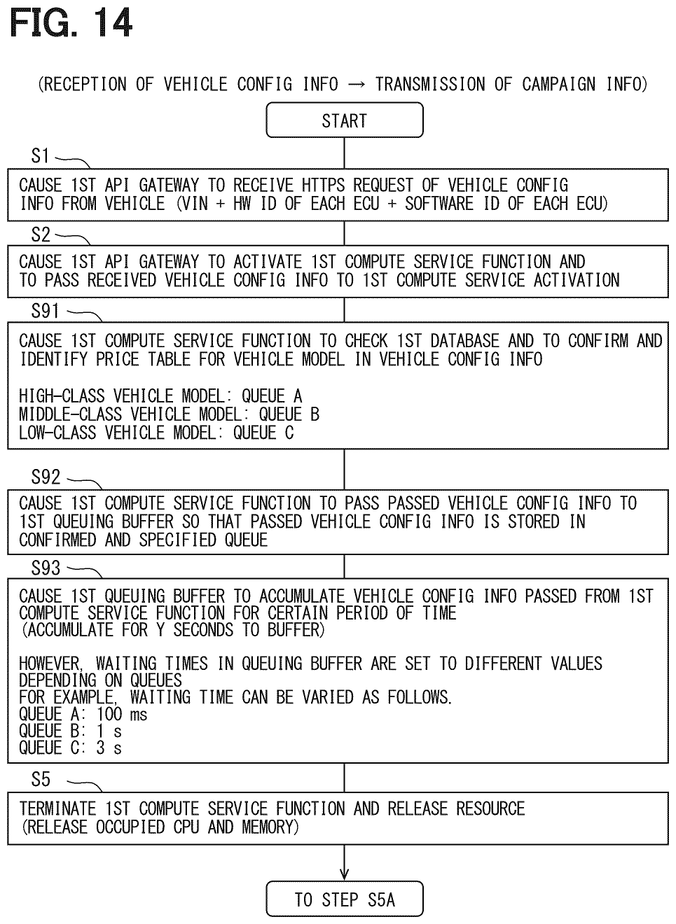

As illustrated in FIG. 14, when steps S1 and S2 are executed, the compute service function section 12 checks the database section 16 to confirm the VIN of the automobile 31 included in the vehicle configuration information, checks a price table on the basis of the VIN, and specifies in which queue in the queuing buffer section 13A to store the vehicle configuration information. For example, a queue A is specified for a high-class vehicle, a queue B is specified for a middle-class vehicle, and a queue C is specified for a low-class vehicle (step S91). The compute service function section 12 is an example of an access buffer control section and a queuing buffer control section. Alternatively, the vehicle configuration information may include information indicating a price range.

The compute service function section 12 inputs the passed vehicle configuration information to the queuing buffer section 13A so as to be stored in the specified queue (step S92). The queuing buffer section 13A accumulates the passed vehicle configuration information for a certain period of time, and the certain period of time is set for each queue. For example, the certain period of time is 100 ms for the queue A, 1 second for the queue B, and 3 seconds for the queue C (step S91). Then, steps S5 to S15 are executed similarly to the first embodiment. The accumulation period in the queuing buffer section 13A is set to be longer in the order of the queue A, the queue B, and the queue C.

As described above, with the second embodiment, even when the present embodiment is applied to a large group of vehicles of several 10 million vehicles, it is possible to preferentially process the vehicle configuration information of the high-class automobile 31, which has a low share and whose vehicle configuration information generates a small amount of traffic, quality of the connected service can be prevented from deteriorating. In that sense, this is a type of quality of service (QoS) control.

### Third Embodiment

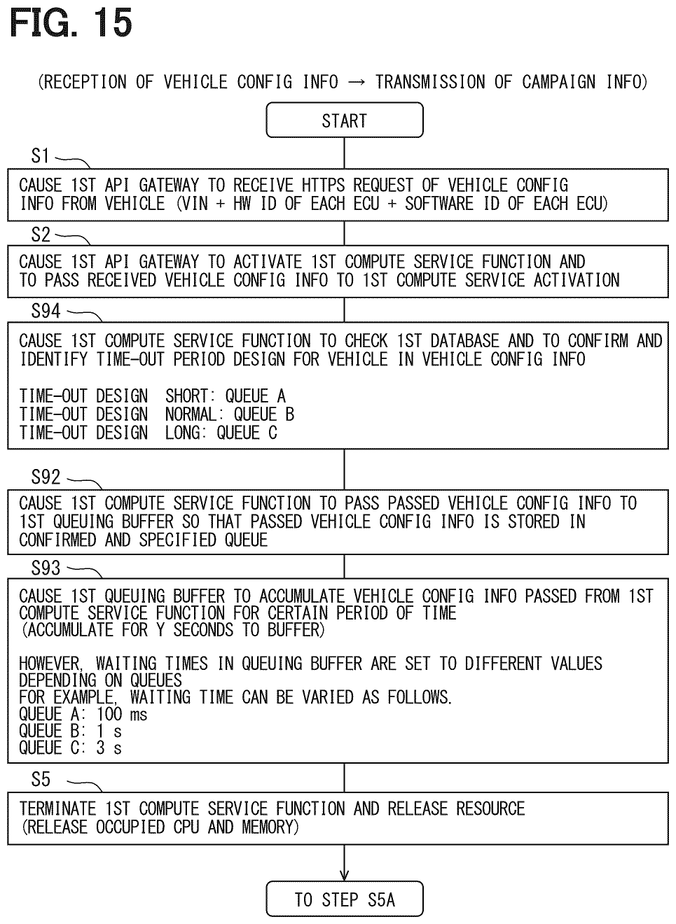

In a third embodiment, instead of the price range of the vehicle in the second embodiment, a time-out period in the queuing buffer section 13A is set in the vehicle configuration information of each vehicle. The time-out period is an index of a time period from when data is input to the queuing buffer 13A to when the data is output through the queuing buffer section 13A. Therefore, as illustrated in FIG. 15, in step S94 instead of step S91, the compute service function section 12 checks the database section 16 to see the time-out period for each automobile 31 included in the vehicle configuration information, and specifies which queue of the queuing buffer section 13A to store the information in. The time-out period here does not need to be a specific numerical value, and the queue A is specified for a vehicle having a “short” time-out period, the queue B is specified for a vehicle having a “normal” time-out period, and the queue C is specified for a vehicle having a “long” time-out period. The subsequent process is similar to the process in the second embodiment. The time-out period may be a predetermined numerical value such as 100 ms, 1 second, or 3 seconds.

### Fourth Embodiment

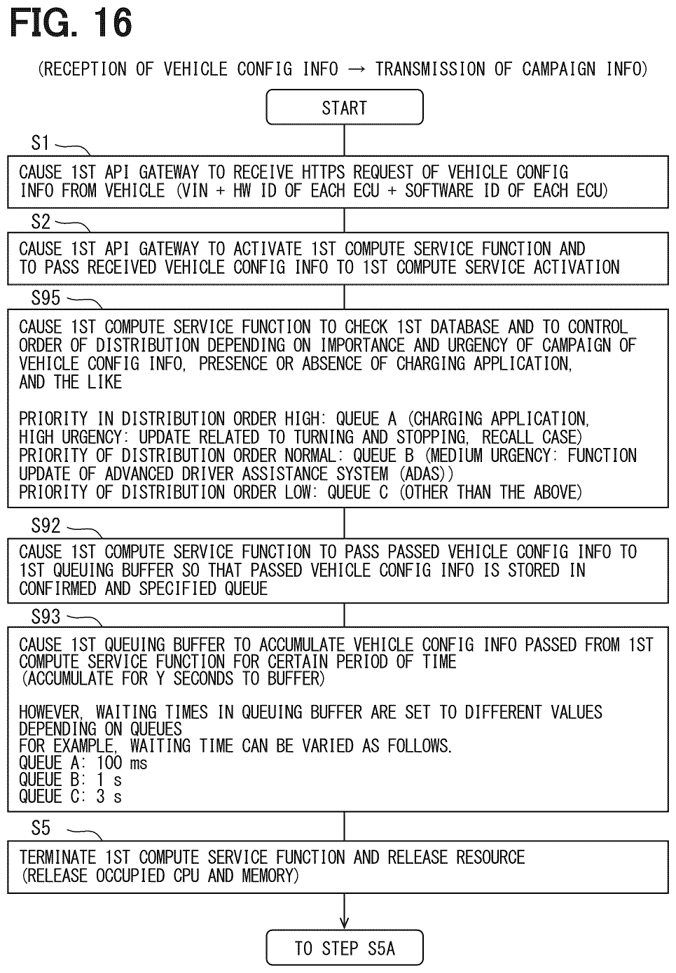

In the fourth embodiment, in the vehicle configuration information of each vehicle there is set, instead of the time-out period in the third embodiment, priority (specifically “high”, “normal”, or “low”, for example) in a distribution order on the basis of importance or urgency of a campaign, presence or absence of a charging application, and the like. Therefore, as illustrated in FIG. 16, in step S95 instead of step S94, the compute service function section 12 checks the database section 16 to see the priority in the distribution order for each automobile 31 included in the vehicle configuration information, and specifies which queue of the queuing buffer section 13A to store the information in. For example, the queue A is specified for a vehicle having “high” priority, the queue B is specified for a vehicle having “normal” priority, and the queue C is specified for a vehicle having “low” priority. The subsequent process is similar to the process in the third embodiment.

In other words, in the fourth embodiment, the priority in the distribution order is set to, for example, “high”, “average”, or “low” on the basis of the attribute of the campaign. The attribute of the campaign is, for example, at least one or more conditions among the following conditions: importance and urgency of a campaign; and whether contents are charged.

### Fifth Embodiment

In a fifth embodiment, similarly to the second embodiment, the price table of the automobile 31 included in the vehicle configuration information is checked to specify which queue to store the information in. In addition, in a case where the vehicle configuration information can be transmitted from an information communication terminal such as a smartphone 32 or a personal computer (PC) 33 in addition to the automobile 31, the compute service function section 12 determines a transmission source and specifies the queue in a queuing buffer section 13B also in accordance with the transmission source. The compute service function section 12 is an example of a transmission source determination section.

With respect to communication processing of the vehicle configuration information transmitted from the automobile 31 that serves as a transmission source, if it is assumed that background processing is performed as in the embodiment to be described later, a response speed from the OTA center 1 does not cause much problem. On the other hand, the communication processing of the vehicle configuration information transmitted from the smartphone 32 or the PC 33 that serves as a transmission source is processed in the foreground; therefore, if the response speed is low, it is a problem in terms of user experience (UX).

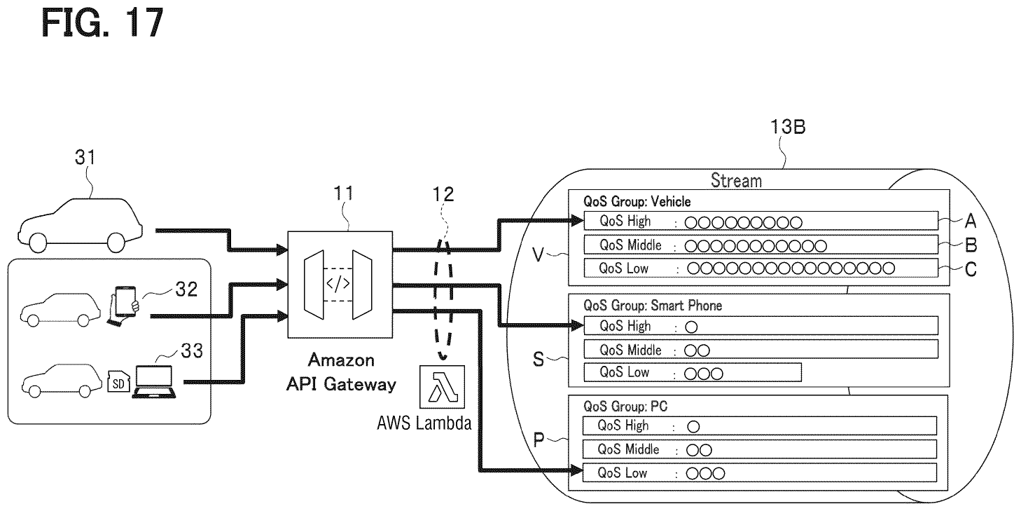

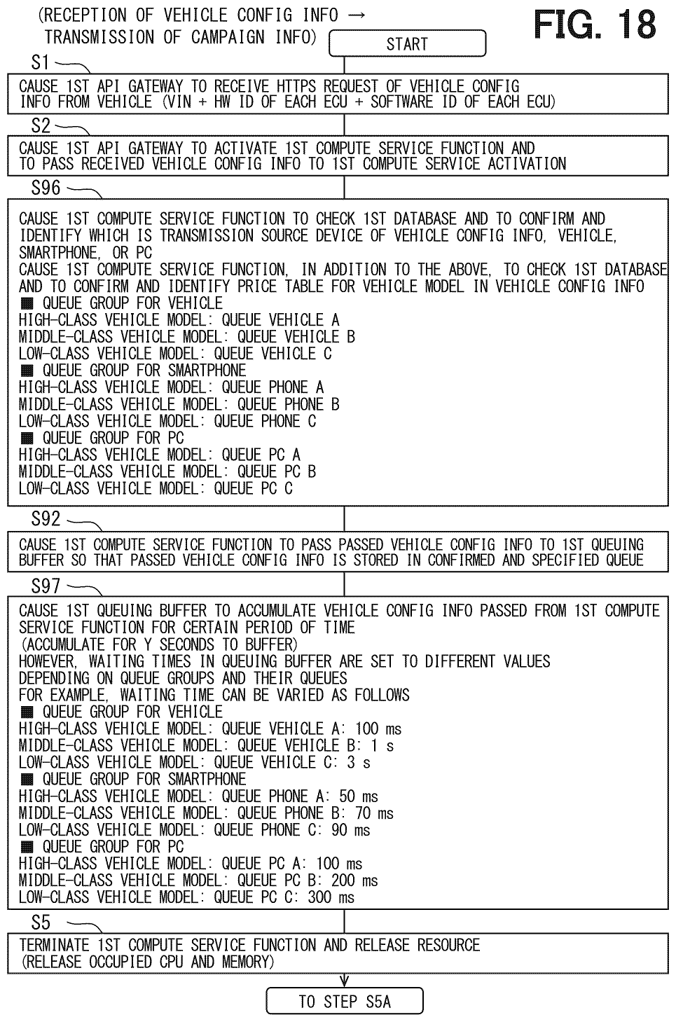

To address this issue, in the fifth embodiment, as illustrated in FIGS. 17 and 18, for example, in step S96 in place of step S95 of the fourth embodiment, the compute service function section 12 checks the database section 16 to identify which of the automobile 31, the smartphone 32, and the PC 33 transmitted the vehicle configuration information. At the same time, the price table of the automobile 31 is checked to specify the queue. In the queuing buffer section 13B, there are a queue group V for automobile 31, a queue group S for the smartphone 32, and a queue group P for the PC 33, and each queue group includes queues A to C. Sorting into the queues A to C on the basis of the price table is performed similarly to the second embodiment.

In step S97 in place of step S93, the processing of accumulating the vehicle configuration information passed to the queuing buffer section 13B for a certain period of time is similar. However, the waiting times of the queue groups V, S, and P are set differently depending on a combination of the transmission source and the price table. For example, the setting is as follows.

### <Queue Group V>

A:100 ms
B:1s
C:3s

### <Queue Group S>

A:50 ms
B:70 ms
C:90 ms

### <Queue Group P>

A:100 ms
B:200 ms
C:300 ms

As described above, according to the fifth embodiment, the waiting time of each queue in the queuing buffer section 13B is changed in accordance with the transmission source of the vehicle configuration information and the price table of the automobile 31, so that it is possible to provide a high-quality OTA service in which users' value experience, in other words, a so-called UX is improved.

### Sixth Embodiment

In the serverless architecture, resources are allocated when an event occurs, so that it takes a relatively long time to activate. Therefore, in a sixth embodiment, the compute service function sections 12, 14, 20, and 24 and the compute service processing sections 15 and 23 adopting the serverless architecture are put into a warm standby state, so that the start-up time is shortened.

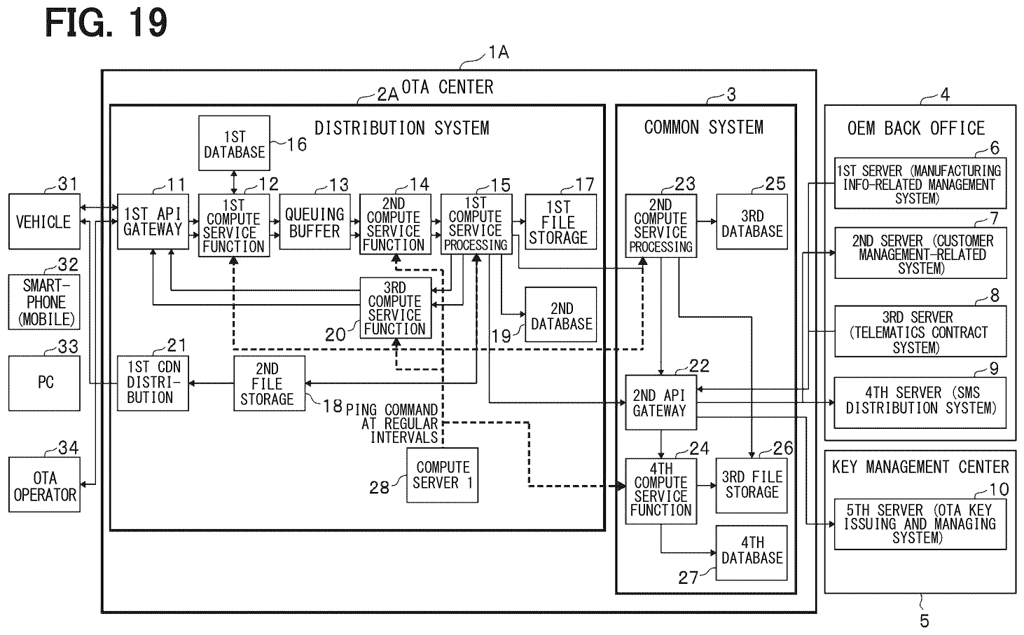

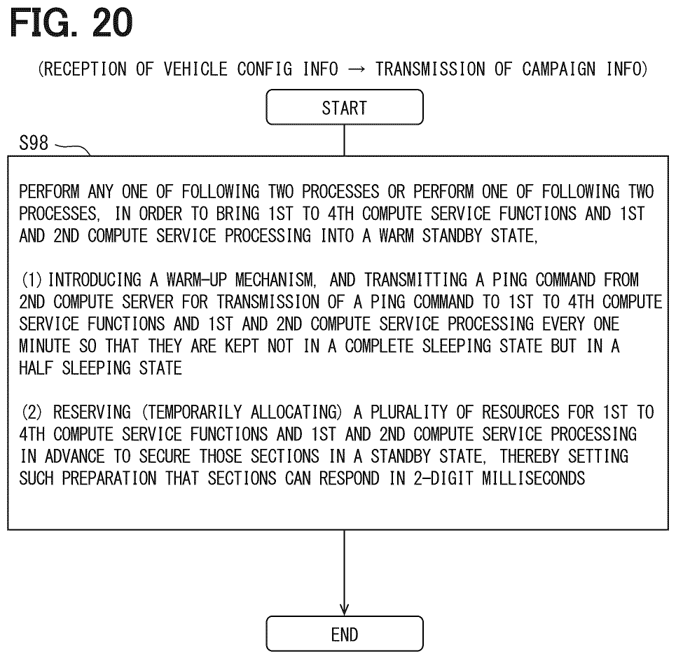

As one method thereof, in an OTA center 1A according to the sixth embodiment illustrated in FIG. 19, a compute server section 28 is added to the distribution system 2A. The compute server section 28 adopts the server architecture and transmits, as a command to check whether communication is possible, a ping command, for example, to the compute service function sections 12, 14, 20, and 24 and the compute service processing sections 15 and 23 at a constant cycle, for example, at an interval of one minute (see (1) of step S98 in FIG. 20). As a result, each of the compute service function sections and the compute service processing sections can be maintained in the warm standby state. The compute server section 28 is an example of a reserve state setting section.

Furthermore, the method illustrated in (2) of step S98 reserves and temporarily allocates a plurality of resources to the compute service function sections 12, 14, 20, and 24 and the compute service processing sections 15 and 23 in advance in the case where AWS is applied, so that a warm standby state can be established. Note that the compute service function sections 12, 14, 20, and 24 may be brought into the warm standby state by setting provisioned concurrent execution to the compute service function sections 12, 14, 20, and 24.

### Seventh Embodiment

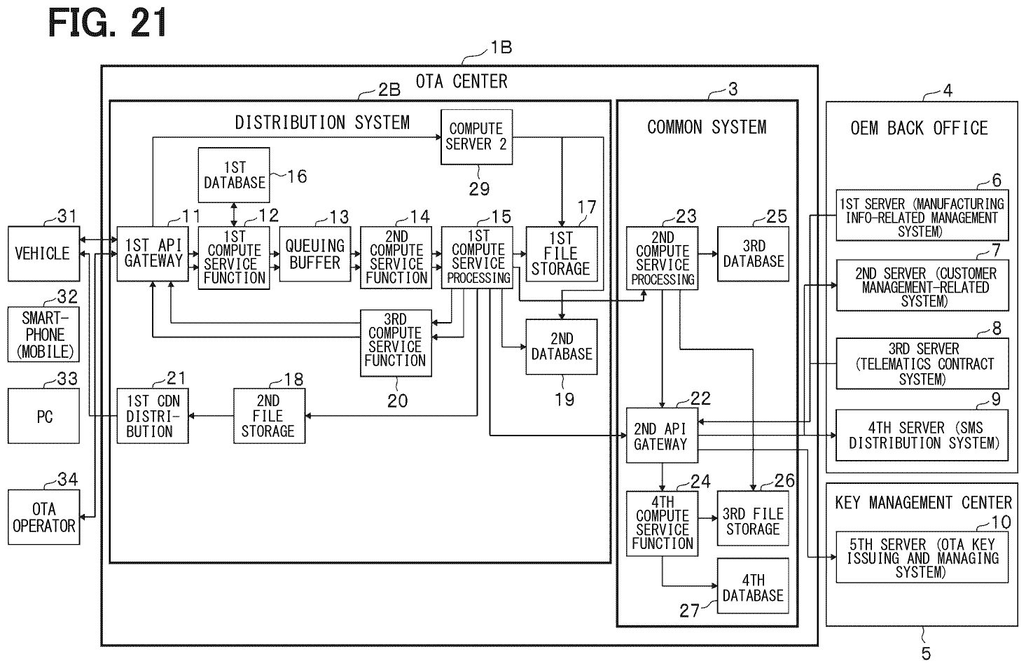

In an OTA center 1B of a seventh embodiment illustrated in FIG. 21, a compute server section 29 is added to a distribution system 2B. The compute server section 29 adopts the server architecture, and inputs and outputs data between the compute server section 29 and the API gateway section 11, the file storage section 17, and the database section 19. The compute server section 29 is an example of an information processing server.

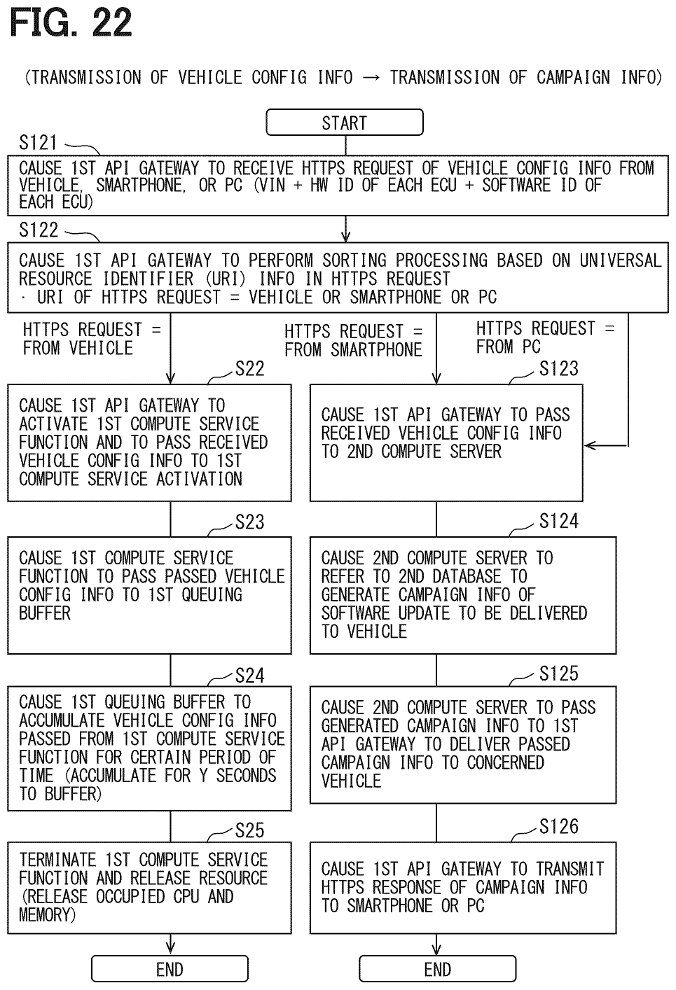

As illustrated in FIG. 22, when an HTTPS request of the vehicle configuration information is received from the automobile 31, the smartphone 32, or the PC 33 (step S121), the API gateway section 11 performs sorting processing of the transmission source on the basis of the URL information included in the HTTPS request (step S122).

When the transmission source is the automobile 31, the process of step S22 and the following steps is executed similarly to the first embodiment. In step S25 and the following steps, similarly to the first embodiment, the API gateway section 11 transmits the HTTPS response including the campaign information to the automobile 31. When the transmission source is the smartphone 32 or the PC 33, the API gateway section 11, which is an example of an information processing control section, passes the received vehicle configuration information to the compute server section 29 (step S123). The compute server section 29 refers to the database section 19 to generate campaign information of software update to be delivered to the automobile 31 (step S124). Subsequently, the compute server section 29 passes the generated campaign information to the API gateway section 11 in order to deliver the campaign information to the corresponding smartphone 32 or PC 33 (step S125). Then, the API gateway section 11 transmits the HTTPS response of the campaign information to the smartphone 32 or the PC 33 (step S126).

When the transmission source is the automobile 31, the compute service function section 12 and the like perform the processing, but in contrast, when the transmission source is the smartphone 32 or the PC 33, the compute server section 29 performs the processing. When the automobile 31 is the transmission source, the processing is performed by the serverless architecture, and the response speed is therefore slower than in the case of the server architecture; however, the running cost required for the infrastructure can be greatly reduced. When the smartphone 32 or the PC 33 is the transmission source, the processing is performed by the server architecture, and the response speed can therefore be maintained, so that the users' value experience can be improved.

### Eighth Embodiment

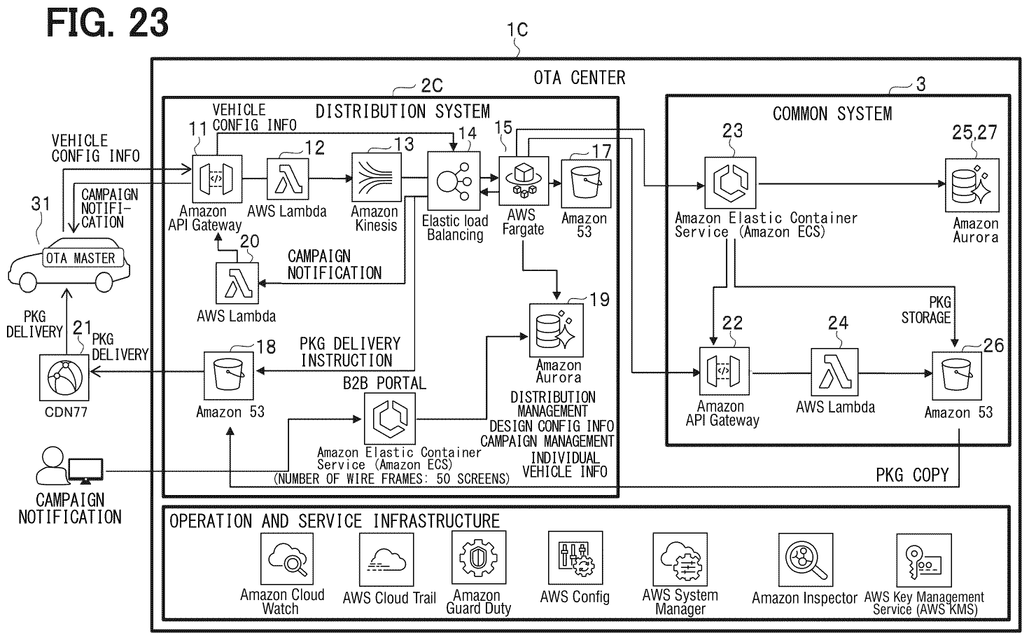

An eighth embodiment illustrated in FIG. 23 illustrates a variation of the OTA center that is illustrated in FIG. 2 of the first embodiment and is configured using AWS. The main difference from FIG. 2 is in the following configuration: some of the functions of “AWS Fargate” are performed by “Elastic Load Balancing”; “Elastic Load Balancing” corresponds to the compute service function section 14; and “AWS Fargate” corresponds to the compute service processing section 15.

### Other Embodiments

The application program adopting the serverless architecture is not limited to those using AWS, and other cloud computing services may be used.

The command periodically transmitted by the compute server section 28 is not limited to the ping command, and only needs to be a command that checks whether communication is possible.

The information communication terminal is not limited to a smartphone or a personal computer.

Examples of features of the serverless architecture will be described. The serverless architecture is an event-driven architecture in which services are loosely coupled. The term “loosely coupled” means that dependency between services is low. The server is further stateless and needs to be designed such that processing and functions do not have a state internally, in other words, do not have a condition. In the serverless architecture, a request needs to be connected statelessly from one service to the next service. In the serverless architecture, configuration is made such that resources can be flexibly changed in accordance with use of a system and a change in load.

In order to design the serverless architecture in this manner, it is necessary to satisfy items that are not taken into consideration in the design of the server architecture. Therefore, a system adopting the serverless architecture cannot be constructed on the basis of a software system configuration, a design, specifications, and the like that are based on the server architecture.

Although the present disclosure has been described in accordance with the embodiments, it is understood that the present disclosure is not limited to the above embodiments or structures. The present disclosure incorporates various modifications and variations within the scope of equivalents. In addition, while the various elements are shown in various combinations and configurations, which are exemplary, other combinations and configurations, including more, less or only a single element, are also within the spirit and scope of the present disclosure.

Means and/or functions provided by each device or the like may be provided by software stored in a substantive memory device and a computer that can execute the software, software only, hardware only, or some combination of them. For example, when the control apparatus is provided by an electronic circuit that is hardware, it can be provided by a digital circuit including a large number of logic circuits, or an analog circuit.

The control circuit and method described in the present disclosure may be implemented by a special purpose computer which is configured with a memory and a processor programmed to execute one or more particular functions embodied in computer programs of the memory. Alternatively, the control unit and the method described in the present disclosure may be implemented by a dedicated computer provided by forming a processor with one or more dedicated hardware logic circuits. Alternatively, the control unit and the method described in the present disclosure may be implemented by one or more dedicated computers including a combination of a processor and a memory programmed to execute one or multiple functions and a processor including one or more hardware logic circuits. The computer program may also be stored on a computer-readable and non-transitory tangible recording medium as an instruction executed by a computer.

What is claimed is:

1. A center device that manages data to be written in an electronic control device mounted on a vehicle and performs, by an application program, a plurality of functions to transmit update data to the vehicle by wireless communication,
wherein
an application program implementing at least one of the functions adopts a server architecture in which a resource is always allocated and that executes as a resident-type process, and
an application program implementing at least one of the functions, other than the at least one of the functions implemented by the application program that adopts the server architecture, adopts a serverless architecture
in which the application program is activated upon occurrence of an event and is dynamically allocated with a resource in an on-demand manner for execution of a code of the application program and
in which the resource allocated to the application program is released when the execution of the code is terminated.

2. A center device that manages data to be written in an electronic control device mounted on a vehicle and performs, by an application program, a plurality of functions to transmit update data to the vehicle by wireless communication,
wherein
an application program implementing at least one of the functions adopts a serverless architecture
in which the application program is activated upon occurrence of an event and is dynamically allocated with a resource in an on-demand manner for execution of a code of the application program and
in which the resource allocated to the application program is released when the execution of the code is terminated.

3. The center device according to claim 2, comprising:
a campaign determination section that receives vehicle configuration information from a vehicle and determines whether campaign information for the vehicle is present;
a campaign generation section that generates campaign notification information for the vehicle when the campaign information is present; and
a campaign transmission section that delivers the campaign notification information to the vehicle,
wherein
an application program that implements functions of the campaign determination section and the campaign generation section adopts the serverless architecture.

4. The center device according to claim 3, wherein
the application program includes:
a first compute service section that transfers the vehicle configuration information received from the vehicle via a gateway section to the campaign determination section; and
a second compute service section that determines, as the campaign determination section and the campaign generation section, based on the vehicle configuration information, whether the campaign information for the vehicle is present and that generates the campaign notification information for the vehicle when the campaign information is present, and
the first compute service section selects and activates an application program included in the second compute service section, in accordance with a content of the vehicle configuration information.

5. The center device according to claim 4, wherein
the first compute service section is activated upon reception of the vehicle configuration information as an event, and
the second compute service section is activated upon an instruction of activation by the first compute service section as an event.

6. The center device according to claim 3, further comprising
a package distribution section that delivers to the vehicle a package including the update data to be delivered to the vehicle,
wherein
the package distribution section performs delivery by transferring an update package associated with the campaign information to a network distribution section, and
an application program that implements a function of the package distribution section adopts the serverless architecture.

7. The center device according to claim 6, wherein
the application program that implements the function of the package distribution section includes a third compute service section that transfers to the network distribution section the update package received.

8. The center device according to claim 3, further comprising
a campaign registration section that registers vehicle configuration information, campaign information of update data for the vehicle, and update data to be distributed together with the campaign information,
wherein
an application program that implements a function of the campaign registration section adopts the serverless architecture.

9. The center device according to claim 8, wherein
the application program that implements the function of the campaign registration section includes:
a gateway section that, when a registration request of the campaign information is input, transfers the campaign information to a fifth compute service section;
the fifth compute service section that transfers to a sixth compute service section the campaign information received;
the sixth compute service section that selects and activates an application program included in a fourth compute service section in accordance with a content of the campaign information; and
the fourth compute service section that registers the campaign information in a database and registers the update data in a file storage section.

10. The center device according to claim 9, wherein
the fifth compute service section is activated upon reception of the campaign information as an event,
the sixth compute service section is activated upon an instruction of activation as an event and receives the campaign information, and
the fourth compute service section is activated upon an instruction of activation by the sixth compute service section as an event.

11. The center device according to claim 9, further comprising
a package generation section that generates a package including the update data to be delivered to the vehicle,
wherein
the package generation section processes the package including the update data into an update package in a format interpretable by a master device that is mounted on the vehicle and transfers the update data received to an electronic control device to be updated, and
an application program that implements a function of the package generation section adopts the serverless architecture.

12. The center device according to claim 11, further comprising
a data management section that transfers, in response to a request from the package generation section, the vehicle configuration information and corresponding update data that are registered in the file storage section, to the package generation section,
wherein
an application program that implements a function of the data management section adopts the serverless architecture.

13. The center device according to claim 3, further comprising
an access buffer control section that buffers and stores, before transferring vehicle configuration information received from a vehicle to a campaign registration section, the configuration information for a certain period of time, and then collectively transfers the vehicle configuration information received within the certain period of time to the campaign registration section.

14. The center device according to claim 13, wherein
the access buffer control section includes:
a plurality of queuing buffers to which priority is assigned in a processing order for each vehicle model; and
a queuing buffer control section that interprets the vehicle model based on the vehicle configuration information and stores the vehicle configuration information in a corresponding queuing buffer,
an application program that implements a function of the queuing buffer control section adopts the serverless architecture.

15. The center device according to claim 13, wherein
the access buffer control section includes:
a plurality of queuing buffers to which priority is assigned in correspondence to a length of a time-out period that is set for each vehicle model and is an index of a time period from when data is input to when the data is output from the access buffer control section; and
a queuing buffer control section that interprets the length of the time-out period based on the vehicle configuration information and stores the vehicle configuration information in a corresponding queuing buffer,
an application program that implements a function of the queuing buffer control section adopts the serverless architecture.

16. The center device according to claim 13, wherein
the access buffer control section includes:
a plurality of queuing buffers to which priority is assigned in a processing order in accordance with an attribute of the campaign information; and
a queuing buffer control section that interprets the attribute of the campaign information based on the vehicle configuration information and stores the vehicle configuration information in a corresponding queuing buffer,
an application program that implements a function of the queuing buffer control section adopts the serverless architecture.

17. The center device according to claim 13, further comprising:
a transmission source determination section that determines, when the vehicle configuration information is transmitted also from an information communication terminal other than the vehicle, a transmission source of the vehicle configuration information,
wherein
the access buffer control section includes:
a plurality of queuing buffers to which priority is assigned in a processing order in accordance with the transmission source; and
a queuing buffer control section that determines the transmission source based on the vehicle configuration information and stores the vehicle configuration information in a corresponding queuing buffer, and
an application program that implements a function of the queuing buffer control section adopts the serverless architecture.

18. The center device according to claim 15, wherein
an information communication terminal is a smartphone or a personal computer.

19. The center device according to claim 3, further comprising
a reserve state setting section that sets a resource that is to be used, to a reserve state before activating at least one or more of application programs adopting the serverless architecture.

20. The center device according to claim 19, wherein
the reserve state setting section periodically transmits to a target application program a command for checking whether communication is possible.

21. The center device according to claim 20, wherein
the command is a Ping command.

22. The center device according to claim 3, further comprising:
a transmission source determination section that determines, when vehicle configuration information is transmitted also from an information communication terminal other than the vehicle, a transmission source of the vehicle configuration information;
an information processing server that adopts a server architecture that a resource is always allocated to and is executed as a resident-type process, the information processing server configured to perform processing of the vehicle configuration information; and
an information processing control section that causes, when the transmission source is the information communication terminal, the information processing server to process the vehicle configuration information received.

23. The center device according to claim 22, wherein
the information communication terminal is a smartphone or a personal computer.
